(19) United States
(12) Patent Application Publication
(10) Pub. No.: US 2022/0261745 A1
(43) Pub. Date: Aug. 18, 2022

(54) SYSTEM AND METHOD FOR DISTRIBUTING PERISHABLE ITEMS

(71) Applicant: Andrzej Nartowicz, Tykocin (PL)

(72) Inventor: Andrzej Nartowicz, Tykocin (PL)

(21) Appl. No.: 17/610,379

(22) PCT Filed: May 9, 2020
(86) PCT No.: PCT/IB2020/054401

§ 371 Date: Nov. 10, 2021

Related U.S. Application Data
(60) Provisional application No. 62/846,437, filed on May 10, 2019.

(51) Int. Cl. G06Q 10/08; G06Q 30/06

(52) U.S. Cl. CPC G06Q 10/0832; G06Q 10/0836; G06Q 30/0641

(57) ABSTRACT

A system for distributing perishable items is described. The system incorporates producers and manufacturers. These deliver their products to distribution points. An end-user of the system places an order through a custom interface specifying both a specific time and location for pick-up. Before the pick-up, the producer or manufacturer delivers the item to the pick-up location. The system uses a data exchange system that communicates user orders from the end-user interfaces to the producers, manufacturers, and distribution points and schedules perishable items for pick-up at the distribution points.

This application claims priority to PCT Application PCT/IB2020/054401, filed on May 9, 2020, presently pending, which in turn claimed priority to U.S. Provisional Application 62/846,437, filed on May 10, 2019, the contents of which are incorporated by reference.

### BACKGROUND OF THE INVENTION

### 1. Field of the Invention

The field of the invention is an integrated system that facilitates the distribution of perishable items along with a and method of use of same to distribute items to customers efficiently.

### 2. Background of the Invention

In various embodiments, the invention provides a system and method for the distribution of an inventory to end-users.

In one embodiment, the invented system comprises several logical and physical layers. At one level, the end customer interacts with the system by placing requests for items, such as by using an appropriate app on a special purpose or general computing device. The requests are forwarded to a distribution network that delivers the requested item to a designated distribution point. The requesting user then retrieves the item at the distribution point, being able to select both the destination location as well as a time of retrieval. The network delivery points comprise another layer of the system, as does the logical network of suppliers fulfilling orders at the delivery points.

In prior art approaches, a single entity would attempt to fulfill most or all functions within the distribution network. For example, traditional vending machine owners are commonly vertically integrated with the wholesale distributors supplying the machines. Prior art approaches create inefficiency and prevent innovative products from being brought to market as every wholesaler seeks to control every aspect of distribution. In such a system, beginning to distribute a new type of product, such as perishable foods, has significant barriers to entry, such as the requirement to build out a distribution network.

A need exists in the art for a system and method of distribution of products to end-users that allows for cooperation throughout the distribution network and allows for a variety of products to be ordered and distributed.

### SUMMARY OF INVENTION

An object of the invention is to create a system and method of distributing products to customers. An advantage of the invention is that it allows for a variety of products to be distributed by a diverse set of suppliers.

Another object of the invention is to facilitate the distribution of perishable items. A feature of the invention is that the distribution points include environmental controls. An advantage of the invention is that it allows for the safe distribution of temperature and time-sensitive perishable items, such as food.

Yet another object of the invention is to provide a system and method supporting just-in-time delivery. A feature of the invention is that the end customer can specify a pick-up time for an order at a pick-up point. An advantage of one embodiment is that the supplier of the perishable items has the ability to ensure the freshness of items on delivery.

A further object of the invention is to provide a system for tracking order status. A feature of the invention is that in one embodiment, each distribution point includes an accounting of the contents of the distribution point, including loading and unloading times. An advantage of the system is that it supports the gathering of information about customer requests and consumption needs.

Another object of the invention is to provide a means for suppliers to enter new markets. A feature of the invention is in one embodiment; independent suppliers can provision the distribution points based on real-time demand. A benefit of the invention is that a supplier can enter a market without building out a network of warehouses and instead can use the existing distribution points.

An additional object of the invention is to allow end-users to place orders for perishable products with different time windows. A feature of the invention is that the end-user can specify both the item to be purchased and the time of delivery while placing the order. A benefit of the system is that the end-user has the flexibility to select both the time and place of delivery.

A further object of the invention is to provide a constant pick-up location for a diverse variety of products. A feature of the system is that in one embodiment, a variety of suppliers provide products to a single distribution point. A benefit of the system is that a single distribution point can be used to pick up a large variety of products.

An additional object of the invention is to provide a system of distribution of perishable products that minimizes waste. A feature of the invention is that the system can indicate the expected demand for products on the basis of real-time orders and expected patterns of demand. A benefit of the invention is that perishable items are not supplied to distribution points only to be wasted.

A further object of the invention is to gather information about products being offered by suppliers. A feature of the invention is that end customers can include ratings and otherwise indicate the level of satisfaction with a purchase. A benefit of the invention is that suppliers of products can see how pleased potential customers are with new offerings.

Another object of the invention is to provide real-time updates about the status of each distribution point. A feature of the invention is that the system includes a variety of sensors about each distribution point. A benefit of the invention is that the operator of the system is able to maintain product quality on a consistent basis throughout the chain of distribution.

A further object of the invention is to provide a system of distributing food with limited personal contact. A feature of the invention is that end customers interact with a meal distribution machine rather than a clerk. A benefit of the invention is that consumers can retrieve healthy and fresh food without interacting with another person.

An additional object of the invention is to sanitize items at the time food is delivered. A feature of the invention is that, in some embodiments, the distribution point is equipped with UV-emitting lights. A benefit of the invention is that food containers and other items can be sanitized before they are distributed to the end consumer.

A system and method of product distribution are described. At least one physical distribution point is used. End-users of the system place orders and designate a time and location of product pick-up at a distribution point. The inventory at the distribution point is replenished based on demand expressed by the end-user orders.

### BRIEF DESCRIPTION OF DRAWINGS

The invention, together with the above and other objects and advantages, will be best understood from the following detailed description of the preferred embodiment of the invention shown in the accompanying drawings, wherein:

FIG. 1 depicts a schematic overview of one embodiment of the invented system;

FIG. 2 depicts an overview of a sample interface screen;

FIGS. 3A and 3B depict additional sample interface screens;

FIG. 4 depicts a flow chart of the operation of one embodiment of the system; and

FIG. 5 depicts a flow chart of the installation and use of one embodiment of the system.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random-access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

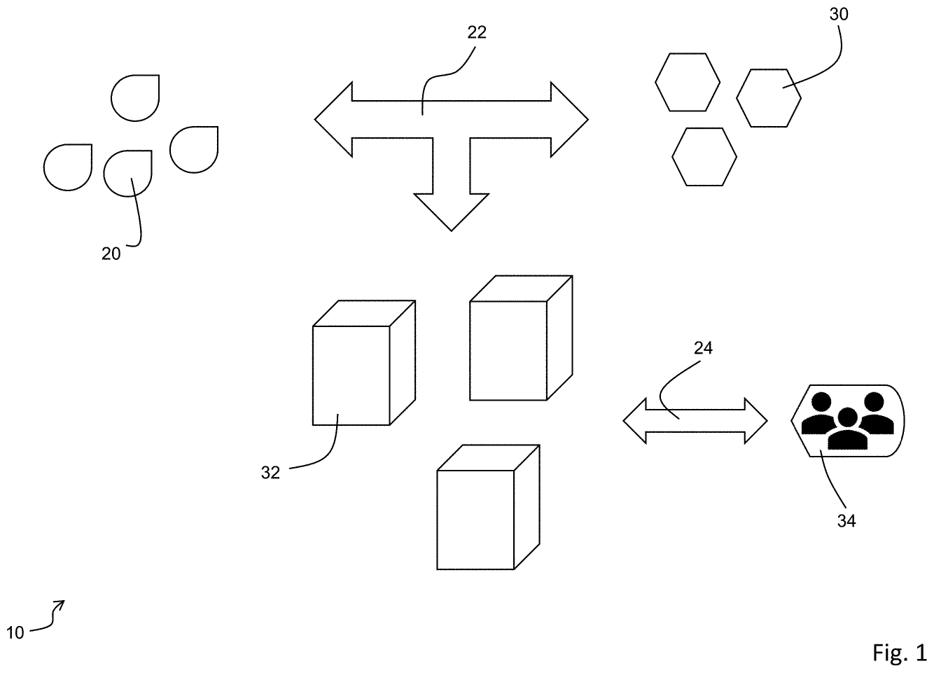

Turning to the figures, FIG. 1, depicted therein, is an embodiment 10 of the invented distribution system. The primary components of the embodiment 10 include the source producers 20, the manufacturers 30, the distribution points 32, and the customer interface 34.

The source producers 20, manufacturers 30, and distribution points 32 communicate to exchange information using the information exchange system 22 depicted as multiple arrows. While the information exchange 22 is depicted as arrows, the system is more than a passive means of exchanging information in one embodiment. The information exchange 22 comprises a means to model demand for products, communicate with the participants in the system, such as manufacturers 30 and the producers 20. The information exchange 22 system is also responsible for communications 24 between the customer interface 34 and the information exchange 22.

In instances where the system 10 is being used to distribute perishable foods, the source producer 20 would refer to the sources of the ingredients, such as the importer or the farm responsible for the food item. The manufacturer 30 would be the restaurant or the catering company that turned the food provided by the source 20 into a sellable item. In some embodiments, the producers 20 and manufacturers 30 are combined into a single entity. For example, a farm may include an on-site food processing plant, such as a dairy containing a cheese-making facility. The distribution points 32 are temperature-controlled, secure vending devices that are filled by the manufacturers 30 or producers 20. At the time the vending devices are filled, the information exchange 22 system is notified so that an appropriate notification is triggered on the end-user interface 34.

While in some embodiments, the distribution points 32 include temperature control features, in other embodiments, where the products being sold are shelf-stable, the distribution points 32 do not use temperature control.

Each distribution point 32 communicates with the information exchange 22 to determine what items are to be picked up at the respective distribution point 32. End users establish accounts in the information exchange 22 to be able to place orders.

In the embodiment shown in FIG. 1, the distribution points 32 can only be accessed using the end-user interface 34 and do not operate as traditional vending machines that allow end-users to place orders by interacting with the vending machine directly.

The distribution points, in one embodiment, are devices with both cooled and heated sections. This allows each distribution point to serve both hot and cold items. The distribution points 32 are designed to minimize the amount of time that each end user requires to pick up their order.

The overall purpose of the system 10 is to improve the quality of convenience food available to the end-users. Worldwide there are billions of workers in workplaces such as factories and offices. The system 10 provides a regular way to access fresh food having a high quality. The amount of time each item has spent waiting is known, and the conditions under which the item was waiting are also subject to strict control in one embodiment.

The manufacturers 30 and the producers 20 benefit from the use of the system 10. These entities have access to new markets, for example, within a closed campus of an institution. Inasmuch as the distribution points 32 are designed to provide highly perishable foods, the producers 20 and manufacturers 30 will need to be from the local area.

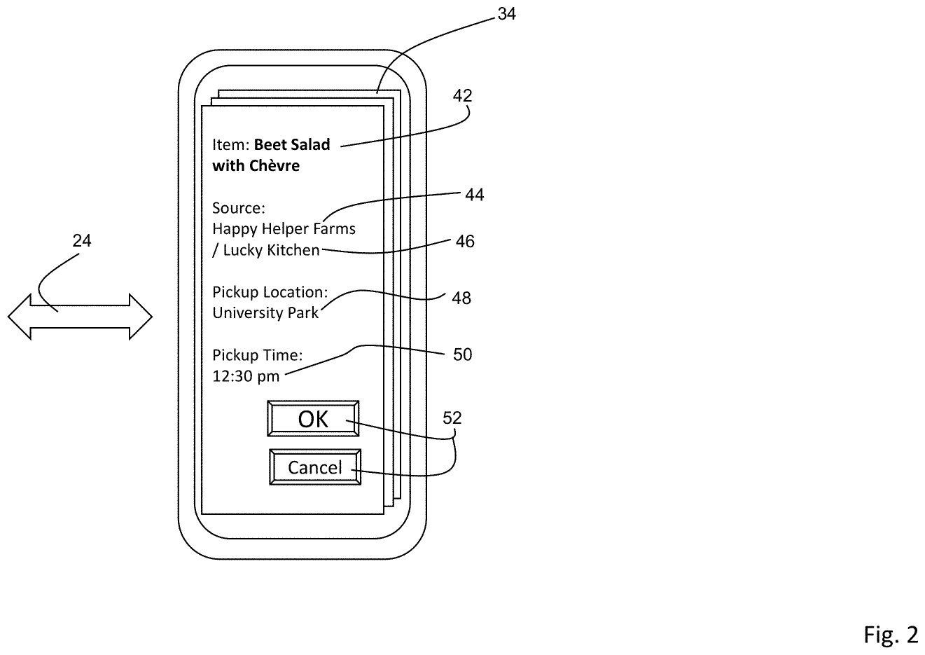

The customer interface 34 comprises a means for each end customer to request inventory from the system 10. A sample end-user interface is shown in FIG. 2. Each end-user has access to a personal account where the end-user can provide information about preferences, dietary restrictions, and any allergies. At the time of pick-up, the end-user can retrieve their order at the desired time, at the requested place, with a guarantee that the order will be exactly as requested. Unlike at a conventional dining establishment, the pick-up process can take a few seconds without requiring the end-user to travel to a particular restaurant. The same distribution point 32 can provide one type of meal on a first day and an entirely different meal on subsequent days.

The distribution of perishable inventory using the system 10 will limit the amount of wasted food and decreases the amount of energy and costs required for the logistics of multi-point distribution. Each supplier 20 and manufacturer 30 can reach a particular market by filling the distribution points 32 and without having to establish a physical presence at a particular location.

In one embodiment, the information contained within the information exchange system 22 is distributed to multiple end-users by using a blockchain-based record-keeping system. The resulting system 10 has a record of delivery from local suppliers, and each supplier is a confirmed source within the system. In one embodiment of the system, the implementation of blockchain technology allows end-users to review multiple levels into the supply chain, including the manufacturer or distributor. In such an embodiment, for a selected meal, the end customer will know not only the final producer, but the origin of the ingredients used to complete the order.

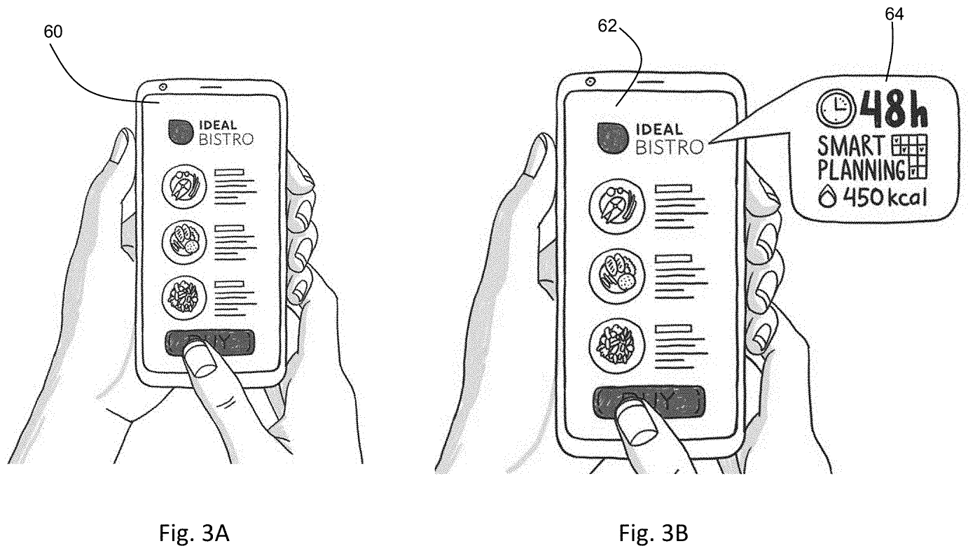

Additional sample interface screens 60, 62 are shown in FIG. 3A and FIG. 3B. As shown in FIG. 3B, the interface screen includes an indication of the total nutritional value of foods 64 consumed during a specified time interval.

As shown in FIGS. 3A and 3B, the user interface is implemented by an app running on an end user's multi-purpose computing device, such as a tablet, smartphone, laptop, or other computing device. The multi-purpose computer is connected directly or indirectly to a central computer system, using a wired or wireless connection such as a local network at a distribution point or a Wifi connection to the internet. The multi-purpose computer device comprises memory, one or more central processing units, a user interface display, and a user interface device such as a touchscreen. The multi-purpose computing device is programmed with computer-executable instructions that are stored in the computer memory and are executed by the one or more central processing units which perform operations to complete the steps described below.

The back-end functions described herein are performed by at least one server, in one embodiment, or a flexible number of servers that provide a changing amount of computer system resources as demand increases. The server or servers provide sufficient data storage and computing power to fulfill the tasks outlined herein with each server comprising at least memory, at least one processing unit, data storage, and computer-readable instructions.

### Data Analysis

The information exchange 22 system performs several types of data analysis to aid in the operation of the system 10. In one embodiment, the analysis comprises modeling the demand at a particular location and creating a profile for that location. While a variety of factors are used to model demand, in one embodiment, these include:
The character of the work being performed at the particular workplace as there are differences in demand between industries and types of employers.
The number of employees working at a particular location.
Whether the employees will receive additional reimbursement for purchases, such as incentives for buying a healthier lunch option.
Number of locations to which food must be delivered.
Number of shifts are in use at the particular location and what are the working hours at the location.
The number and length of food breaks for employees, and the times that the employees generally use for eating.

In one embodiment, following analysis of these and other factors, the information exchange 22 system will suggest changes to the suppliers 20 and manufacturers 30.

The above factors are also used in initially selecting a location for the distribution point 32. The distribution point 32 is customized with individual accounts managed by the system 10.

### Sample Interface

A sample interface 34 is shown in FIG. 2. The end-user is can select and item 42. For many such items 42 the source 44 and the producer 46 are also included. In this way, the end-user can select desired producers if the end-user has a preference for a particular producer.

The end-user can select a particular pick-up location 48, and a pick-up time 50. Finally, the end-user can act on the order by either confirming the same or canceling it. The interface 34 communicates with the information exchange system 22 using wireless communication means 24, shown in FIG. 1, and FIG. 2.

When picking up an order, the end-user interface 34 will display a unique identifier, such as a bar code or password, that the user provides a specific distribution point 32 to be able to pick up an order.

In summary, the system provides multiple benefits. For an employee, the system allows for the ordering of customized, fresh, high-quality meals that can be picked up at a convenient location. The employee can remain focused on other responsibilities. For an employer, the system provides a valuable workplace perk and allows the company to compete with other companies that offer a variety of eating options. The employer can be located in an office space that is further away from trendy eateries while providing employees access to fresh dining options on-site. For the foodservice operator, the system provides a consistent customer base and revenue flows that can be planned for. The system prevents waste and costs associated with stand-alone dining establishments. The environment benefits by avoiding wasteful food production, thereby decreasing the use of chemicals and other stresses on the environment. Preordered food means a planned and thoughtful choice. Food production vs. needs score is 1:1. There is limited waste, less water use, and less pollution.

The system allows an employee to preorder preferred meals and to collect them at the office without a prolonged wait. The employer company can offer its customers or employees a built-in technological solution that outrivals other available solutions in nutrition. Customers benefit from easy, convenient access to healthy meals from a local caterer that are delivered directly to the workplace at a specific time.

In one embodiment, the system is referred to as a Meal as a Service, or MaaS.

In one embodiment, the goal is to improve the lives of billions of employees in factories and offices by providing them with regular access to fresh, high-quality meals produced by local suppliers. To achieve this goal, in one embodiment referred to as the Ideal Bistro system, allows anyone to plan their own diet and order their favorite meals even one month in advance. Each employee is able to pick up the meal at a convenient time of the day at a location as close to their workplace as possible with a 100% guarantee that they will get what the employee chose. In one embodiment, the whole process will take 3 to 4 seconds. The system significantly reduces the amount of food waste.

### System Deployment

In one embodiment, the deployment of the system consists of the following steps.

First, food producers are chosen according to criteria agreed upon by the workplace, which include expectations of the number, type, and nutritional value of the meals on the menu. Prior to selection, each producer is verified in the way the meals are prepared and transported in order to maintain their quality and freshness. Further, potential partners are verified for compliance with legal requirements. Only local companies that are able to meet the expectations are chosen as potential suppliers or manufacturers.

In one embodiment, at the same time, the customer's requirements related to the need to provide meals to the employees of their company are quantified and analyzed. When working out the system assumptions, the system takes into account the specific working conditions of our customers, especially:
a. The character of the work being performed at the particular workplace as there are differences in demand between industries and types of employers.
b. The number of employees working at a particular location.
c. Whether the employees will receive additional reimbursement for purchases, such as incentives for buying a healthier lunch option.
d. Number of locations to which food must be delivered.
e. How many work shifts are in use at the particular location and what are the working hours at the location.
f. The number and length of food breaks for employees, and the times that the employees generally use for eating

On the basis of information resulting from the analysis of a combination of many factors, the offered system is customized. Importantly, the system as implemented is custom for a particular deployment and addresses the gap resulting from the limitations of the existing solutions.

In the last stage, on the basis of a previously prepared plan, the implementation of Ideal Bistro is initialized. The system consists of:
a. The application (Pay2vend)-(I.A., Big Data), a system of individual consumer accounts that manage the whole process of ordering and receiving meals in Ideal Bistro.
b. The distribution points or “foodomats” and other machines (IoT), managed by a service, such as one provided by Pay2vend, which allow anyone to freely receive individual orders within 3-4 seconds.

The deployment and implementation occur in two tracks, in some embodiments:
a. First, user accounts are created in the application, which allow users to:
   place orders—in the user panel, we place a menu with all necessary information, such as weight, nutritional value, and allergy information
   pay for an order—the user manages his/her payments
   view order receipts
b. Then, in indicated locations, Foodomats and other machines are used to collect meals and food.

The end result is a technology that supports companies in improving the health, productivity, and job satisfaction of their employees.

### Impact on Existing Distribution Methods

In one embodiment, the system is designed to influence the environment from the distribution of goods to the distribution of value. Looking for an answer to the question of how to better provide food at work, the system provides a solution that will resolve several issues:
1. The system enables billions of employees worldwide to take care of their own well-being and health at the peak of their activity during the day.
2. The system makes it easier for millions of businesses to take care of their employees by organizing a convenient process for accessing personalized food at work that can also be used to take food home. A company can highlight the value of employee health by financing their meals.
3. The system reduces the amount of wasted food by planning it at every stage of the supply chain.

The system is designed to support efforts at fighting against the diseases of the 21st century, i.e., obesity or diabetes, supporting preventative actions. The effects of these actions have a measurable impact on the economy. Another opportunity presented by the system is the collected data on the daily shopping habits of hundreds of millions of consumers to improve the distribution and use of food worldwide. The system facilitates the production of food in millions of small, local kitchens, creating a new ecosystem. New products are developed and manufactured on the assumption that they will be consumed within a short period of time. Even candy bars, snacks, and drinks can be fresh and healthy. Thanks to technology, the consumer will be able to verify where the ingredients and raw materials of the dish come from. In one embodiment, hundreds of millions of distribution points change the way meals are distributed and food that customers can conveniently receive in the workplace.

The system competes with entities such as mass catering in companies. At the moment, they are mainly internal cafeterias and catering companies. These solutions generate problems both for the company and for the suppliers of the service themselves. Based on the organizational aspects, there are five major limitations of the traditional model:
1. The distances between the cafeterias and the individual production halls are large enough for a part of the crew to be unable to take advantage of them due to the excessive time needed to reach their destination
2. Serving simultaneously, for example, several hundred dishes takes too much time, and a part of the crew resigns from a meal at the sight of the line of waiting people
3. The process of meal serving/purchasing itself takes more than 2 minutes per employee because the consumer usually makes his or her choice at the time of purchase, plus the time it takes to serve and pay
4. The cafeterias operating in the factories typically do not operate 24/7
5. Dishes sold in the cafeterias are usually very limited in variety, which makes it impossible to respond to the individual nutritional needs of employees.

In one embodiment, the system eliminates the limitations resulting from the hitherto existing model of organization. The embodiment's approach, in this case, goes beyond the prior art. The system is not a food producer, and other companies involved in this business are valuable partners. Thanks to the distribution method, an embodiment creates a model of food distribution from scratch in the company, but can also provide a valuable supplement to the existing traditional solution. When proposing a completely new solution in a company with organized food distribution for employees, the system does not need to eliminate the old well-known, safe system and introduce a new, unknown solution.

In summary, one embodiment of the system is aimed at people who want to improve their quality of life through better nutrition. There are many people declaring that they are working towards this goal. However, most of them never achieve their goals, mostly because of the hardships of everyday life. In one embodiment, the system allows a user to reach their goals with little effort. Once in a while (even once a month), each of them has to plan what they would like to eat in the nearest future. Planning gives measurable benefits to each of the participants in the process, which is also the key to achieving another important social goal, which is to reduce the amount of food waste. In one embodiment, the system works by:
1. The consumer orders at least two days in advance.
2. The company preparing meals has at least two days to collect the required ingredients in the necessary quantities and to prepare for the production process (nutritionally valuable dishes usually require more time to prepare).
3. An important element of the process is the fact that while accepting an order in a shopping cart, the customer simultaneously pays for it—it gives the supplier 100% confidence that each order will be paid for, which has an impact on the reduction of the price of the meal.
4. At the end of the day, the consumer gets a meal that meets his or her expectations at an attractive price, sure to be available for pick up at a convenient time
5. A catering company can accurately plan its purchases, minimizing food waste from unused and unsold meals and ingredients.

In one embodiment, the system has the potential to create a new global marketplace and an innovative food distribution process. The embodiments use workplaces as locations for the collection of food. The embodiments engage in new technologies in the MaaS (Meal as a Service) process.

In one embodiment, the system's deployment requires the design and implementation of the process of mass nutrition in companies that are concerned with the well-being and health of employees. The deployment adapts to the specific conditions of each of the companies, so while designing each solution, the installation takes into account many factors resulting from the specificity of work of a company to the geographic location and availability of producers. The compatibility of Ideal Bistro with existing solutions on the market gives the system a wide range of possibilities. In a selected company, an installation creates a dedicated solution from scratch or adapt to the existing ones, filling in the gaps resulting from the limitations of the existing food system. A good example of this are cafeterias, which are usually not able to service companies working in 24-hour mode. Identifying specific deficiencies, we are able to quickly correct them on the basis of foodomats (IoT), i.e., devices that allow you to collect ordered meals within four seconds, and pay2vend.com technology (A.I., Big Data, Blockchain).

The development of technologies related to Ideal Bistro allows the system to achieve its main goal. The system creates a platform for the exchange of information between food producers, suppliers, and consumers (Industry 4.0). The system is used to re-program the distribution process. The system acts as a tool that makes it possible to change a typical food consumer into a prosumer.

In one embodiment, Ideal Bistro is not limited to providing food for company employees. The system addresses the challenges faced by employees during a working day when they are tempted to make the wrong dietary decisions. We believe that thanks to us, proper nutrition will supplant actions aimed at eradicating hunger. The system creates new expectations and rules for eating by providing MaaS—Meal as a Service.

In one embodiment, the system allows the end customers to choose a food product on many levels: the origin of the ingredients, the date of production of the ingredients, the manufacturer, the date of production of the food, and many others that are important to the end customer individually. The system, in one embodiment, creates a reality where food is produced in millions of small local businesses without needing contact with each individual end customer. The technology gives direct business interaction between end-users and food suppliers at every stage, without requiring in-person interaction. In one embodiment, the system engages managers and business decision-makers to co-create the new food distribution network that can create the places where we spend most of our time in our adult lives—offices and factories. The system supports taking food home from there.

### Summary of Use of One Embodiment

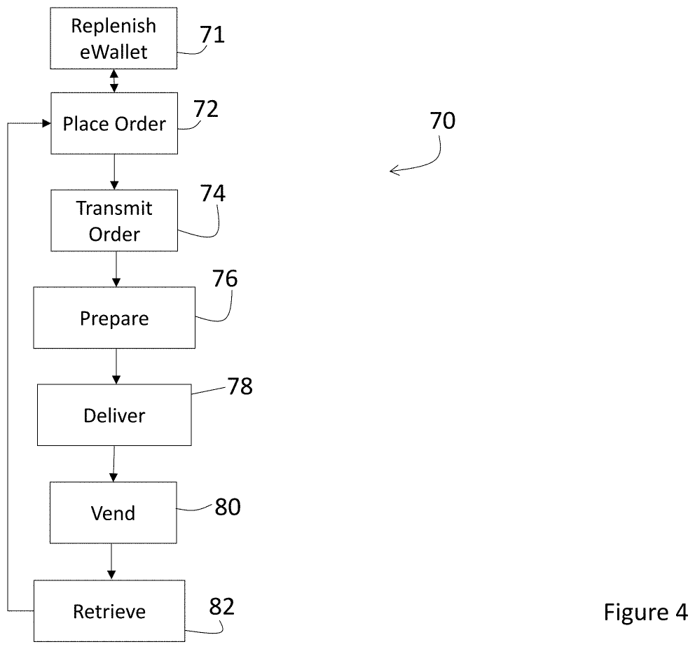

Turning to FIG. 4, depicted therein is a flow chart showing the use of the system pursuant to one embodiment 70. The process begins by the end-user placing an order 72 and paying for their order from an electronic wallet. If needed, the end-user will replenish their electronic wallet 71 prior to placing the order, in some embodiments. In some embodiments, all orders are pre-paid at the time of pick up from an electronic wallet balance. In this way, the end-user does not need to pay for the order at the time of pick-up. Funds are already available, and the pick-up can proceed as quickly as possible.

As detailed above, placing the order 72 within the system allows the user to select not just fixed menu items, but in one embodiment, the user interface allows the customer to select details such as suppliers and types of ingredients. In one embodiment, the end customer can select that certain elements of the food item be organic, such as root vegetables, and others can be grown conventionally.

In one embodiment, the order placement 72 occurs with at least a 48-hour lead time. In other embodiments, the order placement 72 occurs with a variable lead time, depending on the type of item being ordered. For example, ready-to-eat items may not require any lead time.

Once the end customer places the order 72, the system transmits the order 74 to all participants in the supply chain. The system designates one participant as responsible for delivery of the finished product; in one embodiment, for example, a restaurant may be the designated responsible party for delivering the ordered item.

Upon receiving the transmitted order 74, the supply chain participants will prepare 76 the order. During the preparation step 76, in one embodiment, the system allows the end customer to see the progress of the order. In another embodiment, the system allows the end customer to make changes to their order during preparation, by, for example, requesting additional ingredients or making substitutions.

Following preparation and packaging, the responsible party will deliver 78 the order to the distribution point. During the delivery step 78, the system ensures the freshness of the order by tracking of temperature ranges and any delivery delays. Suppliers that fall below quality metrics, for example, by taking too long to deliver items, are noted by the system. In one embodiment, the information about performance by each supplier is shown to the end-user as part of the ordering interface so that the customer can decide whether to place the order using that particular supplier.

Following delivery, the order is placed in the distribution point and vended 80 to the end customer. The distribution point will complete the finishing steps, such as reheating the food. In one embodiment, the distribution point includes a sanitizing system, such as one using ultra-violet light, sanitizing solution, or a combination of several sanitizing methods. The exterior of the order container is therefore sanitized, in one embodiment. In another embodiment, the distribution point provides reusable utensils to prevent creating waste, and the reusable utensils are sanitized before being given to the end-user.

As discussed above, in one embodiment, the end customer can select a time when the order is to be retrieved 82. At the time the order is due to be retrieved, the distribution point will alert the end customer by sending them a notification or another message through the app interface, as shown in FIGS. 3A and 3B.

At the time the end-user is retrieving 82 the order, the end-user is provided additional information, such as information about the chain of supply, in one embodiment. The distribution point, therefore, acts as an additional means of advertising in one embodiment. The distribution point can also provide non-commercial messages, such as health information or reminders to the end customer.

The embodiment of the system as described above uses the following features to accomplish its goals in a novel way: a U.V. disinfecting lamp at the distribution point or vending machine, a mobile application which is used to retrieve orders from compartments, a back-end database which maintains a chain of responsibility for the order starting with the initial supplier (such as a farmer). In one embodiment, the system also supports a virtual wallet to facilitate payments.

In at least one embodiment, the system includes communications between various devices such as a coffee machine or a dispenser of fresh fruit juice or another drink dispenser.

In one embodiment, the system includes an artificial intelligence-driven suggestion algorithm that will provide suggestions for orders to customers. In at least one embodiment, the suggestion algorithm performs automatic orders on behalf of customers.

In one embodiment, the distribution points are stationary and found in defined locations, with the client choosing which location to pick up the order and the time of pick-up. The orders are prepared by certified providers, such as restaurants, and are not simply reheated foods typical of vending machines. The range of foods available at the applicant's system is much higher than the variety of foods that would be available if the food would have to be prepared locally. For example, such robotic food preparation vending points are limited to offering foods such as pizzas and crepes.

The present system focuses on individual orders and the customer experience at the time of pick-up, and not on efficiency in the distribution chain. Many solutions exist to improve the logistics of distributing large quantities of groceries, including using vending machines. In such systems, there is no opportunity to customize the order, as is possible with the present system.

In the embodiments described above, the distribution points do not prepare meals. The distribution points facilitate the pick-up of a large quantity of custom orders in a short amount of time. The orders were placed previously and by registered users who pre-paid using a virtual wallet. The process is subject to supervision and control, including prevention of contamination and by limiting the need to interact with staff at the time of pick-up of the food order.

As described above, the system provides a meal as a service (MaaS) to individuals and employers. On the employer side, the system empowers employers to provide workers with fresh, healthy meals by making the process of food delivery safe and secure. The foods offered by the organization are high-quality and delicious, without forcing the employees to leave the work area. The primary components are a smartphone app, and a distribution point referred to as a foodomat in one embodiment.

The system solves the problem faced by many employers who want to provide a safe work environment without employees congregating at lunchtime. The system allows employees to retrieve healthy and fresh foods from a safe and hygienic location without interaction with another person.

In use, the system allows employees to place orders and pick-up meals. Over time, the machine learning and A.I. algorithm, the system will provide suggestions both to consumers and to participants in the distribution channel to improve preparation logistics of the meals by predicting meal ordering patterns and optimizing nutrition plans for each user.

As part of one embodiment, the system provides a process and technological solution that interconnects foodomats with other devices that prepare foods or drinks. For example, in one embodiment, the foodomats are connected in a system with a juicer that extracts fresh juice from oranges, apples, and other fruits. In another system, a foodomat is connected to a coffee maker that grinds fresh coffee and dispenses fresh cups of coffee. All processes related to the selection of a main entre or product along with the drink and the payments occur within a single centralized application for these ancillary devices as well as the foodomats. The process of pick-up of the food or drink involves placing the phone or other identifying card or token, which identifies the order and the user. At that time, the previously selected and paid-for product is dispensed to the user. In this embodiment, the main food item is dispensed from the foodomat while concurrently, the drink is dispensed from the drink maker (such as fresh juice from the juicer).

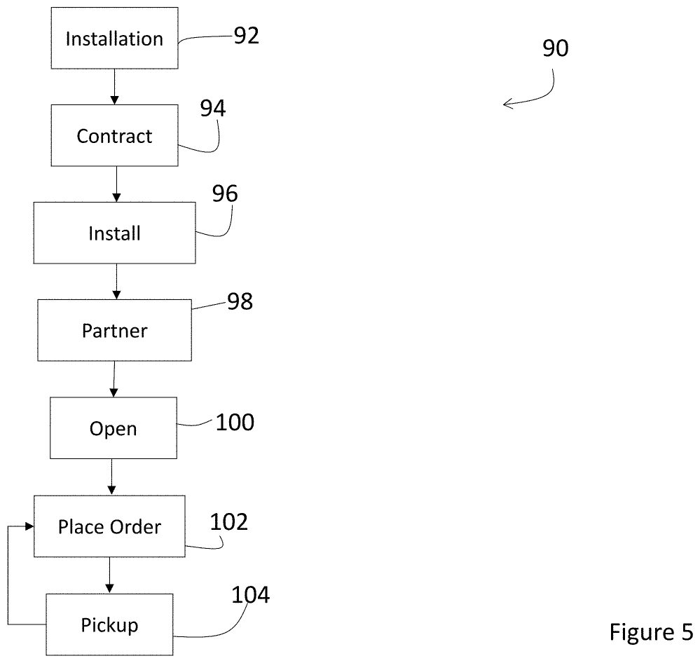

As shown in FIG. 5, the system rollout 90 occurs by first installing 92 a distribution point or foodomat. The party responsible for the location will sign a contract 94 and install 96 the device based on the customer's expectations of use. A food specialist then contacts the responsible party to partner 98 with local restaurants and plan a menu to meet the need of the location.

Once installed, the foodomat is made available 100 to consumers. Each user selects a meal along with the day and time of pick-up 102 from the associated app. The orders are then prepared and delivered to the selected foodomat. The consumers then pick up order 104 after being notified of the delivery.

The pick-up occurs in a safe and convenient manner from the designated foodomat. The customers do not have to leave the premises. In one embodiment, the foodomat doors are opened using scanning of a contactless means, such as scanning a barcode or reading the code from an NFC chip. In such embodiments, the consumers do not have to touch any control panel on the foodomat. Their order is presented to them after the consumer presents the appropriate order retrieval token.

A benefit of the system is that it allows for the building of a highly hygienic and maintenance-free cafeteria, which also provides a large variety of food items.

In order to finance the system and especially the distribution point, in one embodiment, the customers pay a monthly subscription fee, which can be offset by the employer and offered as a benefit. The food ordered through the system will include a margin that is shared with the host of the distribution point.

In one embodiment, the system includes a specially designed payment system. In an embodiment, the payment system comprises a virtual wallet where the end-users transfer funds to the virtual wallet. The orders are pre-paid, allowing for fast pick-up. If an end-user is dissatisfied with their order, they can submit a refund request while interacting with the system app. The end-user does not need to contact the operator of the distribution point or the supplier of the order. The processing of the refund is done within the app. Information about refunds is transmitted to the system and the recommendation engine, in some embodiments. In such embodiments, the end-user will not receive recommendations to order from suppliers who have similar offerings as suppliers where the end-user has previously requested refunds. In one embodiment, the system allows the end-user to specify the reason for requesting a refund. For example, the end-user may have been unhappy with the type of food or the container it came in, or the freshness of the food. In one embodiment, the system will also disfavor suppliers with multiple refund requests.

In some embodiments, the end-user can add a tip to their order either at the time the order is placed, at the time of pick-up, or after the order has been consumed. The system app facilitates the tip function, which is likewise paid for using the end user's electronic wallet, in one embodiment.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. A system for distributing perishable items comprising:
at least one producer of items;
zero or more manufacturers of items, wherein said manufacturers convert source materials from said producers;
at least one distribution point wherein said at least one producer and zero or more manufacturers deliver perishable items to said distribution points;
at least one end user interface which allows for purchasing of a perishable item for pick-up at a particular distribution point at a particular time; and
a data exchange system which communicates user orders from the end user interface to said producers, manufacturers, and distribution points and schedules perishable items for pick-up at the distribution points.

2. The system of claim 1 wherein said at least one distribution point comprises a vending device where end users retrieve items by presenting a unique identifier.

3. The system of claim 1 wherein said at least one distribution point comprises temperature controlled compartments allowing for both heating and cooling of contents thereof.

4. The system of claim 1 wherein said end user interface is shown on a general purpose computing device.

5. The system of claim 1 wherein said perishable items are temperature sensitive and have a limited window of freshness.

6. The system of claim 1 wherein said at least one distribution point is in communication with one or more additional dispensers.

7. The system of claim 6 wherein one of said additional dispensers comprises a fresh juice dispenser.

8. The system of claim 6 wherein one of said additional dispensers comprises a coffee dispenser.

9. The system of claim 1 wherein said at least one distribution point further comprises a wireless signal reader to open compartments within said distribution point without physical contact.

10. The system of claim 1 wherein said distribution point further comprises at least one disinfection method.

11. The system of claim 10 wherein said disinfection method comprises a light source emitting U.V. radiation.

12. The system of claim 1 wherein said user interface is shown on a multi-purpose computing device.

13. The system of claim 1 wherein said data exchange system includes a suggestion engine providing recommendations to end users, and manufacturers.
